(19) United States
(12) Patent Application Publication
(10) Pub. No.: US 2009/0270577 A1
(43) Pub. Date: Oct. 29, 2009

(54) PRESSURE-SENSITIVE ADHESIVE COMPRISING A C10 ALKYL (METH)ACRYLATE

(75) Inventors: Cornelis Petrus Beyers, Altrip (DE); Wolfgang Gaschler, Ludwigshafen (DE); Dieter Urban, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/441,536

(22) PCT Filed: Oct. 22, 2007
(86) PCT No.: PCT/EP2007/061283

§ 371 Date: Mar. 17, 2009

(30) Foreign Application Priority Data
Oct. 23, 2006 (EP) 06122720.3

(51) Int. Cl. C08F 220/10

(52) U.S. Cl. 526/328

(57) ABSTRACT

A pressure-sensitive adhesive comprising a synthetic polymer binder, wherein the polymer has been synthesized from 10% to 100% by weight of a C10 alkyl (meth)acrylate and the alkyl group of the C10 alkyl (meth)acrylate has a propyl group as substituent (referred to subsequently as C10 alkyl (meth)acrylate).

The invention relates to a pressure-sensitive adhesive comprising a synthetic polymer binder, said polymer having been synthesized from 10% to 100% by weight of a C10 alkyl (meth)acrylate and the alkyl group of the C10 alkyl (meth)acrylate having a propyl group as substituent (referred to subsequently as branched C10 alkyl (meth)acrylate).

With pressure-sensitive adhesives (PSAs) there is a desire for effective adhesion to the substrate. In particular the adhesion ought to be effective even on apolar substrates, such as polyolefin substrates, for example.

PSAs based on aqueous polymer dispersions which are obtainable by emulsion polymerization have been known for a long time. They include, in particular, polyacrylates. In emulsion polymers of this kind, an improvement in adhesion or else in cohesion (internal strength) has to date been achieved through selection of suitable comonomers or additives. By way of example, reference may be made to DE-A 103 23 048, whereby positive effects are obtained by adding silicon compounds to the polymer dispersion.

EP-A 625 557 discloses PSAs comprising hydroxyalkyl acrylates.

(Meth)acrylic esters of 2-propylheptanol and processes for preparing the ester are described in DE-A 100 36 879 or else in JP 05070404. JP 05070403 likewise describes the preparation and refers to a suitability for copolymerization with tacky monomers, such as n-butyl acrylate or 2-ethylhexyl acrylate, for example.

An object of the present invention were pressure-sensitive adhesives featuring improved adhesion, even on apolar surfaces.

It is to this effect that the invention has provided the pressure-sensitive adhesive defined at the outset.

The pressure-sensitive adhesive comprises a synthetic polymer binder. Reference below to C10 alkyl (meth)acrylates or other monomers as constituents or synthesis components of the polymer is of course always to the copolymerized form of these monomers.

The C10 alkyl group of the C10 alkyl (meth)acrylate is an alkyl group having a propyl group substituent (according to the rules of nomenclature the longest possible linear chain of the C10 alkyl group is ascertained and a determination is made of whether this chain has a propyl group substituent). The C10 alkyl (meth)acrylate used in accordance with the invention is therefore referred to below as branched C10 alkyl (meth)acrylate.

The compound in question is, in particular, 2-propylheptyl (meth)acrylate,

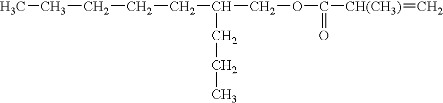

or 4-methyl-2-propylhexyl (meth)acrylate,

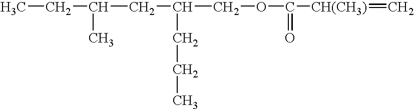

or mixtures thereof.

Preferred mixtures of the branched C10 alkyl (meth)acrylate are composed of

1% to 99% by weight of 2-propylheptyl (meth)acrylate and
99% to 1% by weight 1% to 50% by weight of 4-methyl-2-propylhexyl (meth)acrylate.

Particularly preferred mixtures are composed of

50% to 99% by weight of 2-propylheptyl (meth)acrylate and
1% to 50% by weight of 4-methyl-2-propylhexyl (meth)acrylate.

In one particular embodiment the mixtures are composed of 80% to 95% by weight of 2-propylheptyl (meth)acrylate and of 20% to 5% by weight of 4-methyl-2-propylhexyl (meth)acrylate.

The polymer is preferably composed of at least 30% by weight of the branched C10 alkyl (meth)acrylate, more preferably of at least 50% by weight, and very preferably of at least 70% by weight of the branched C10 alkyl (meth)acrylate.

Besides the branched C10 alkyl (meth)acrylate, the polymer can comprise further monomers, particularly so-called principal monomers, selected from other C₁ to C₂₀ alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Examples include (meth)acrylic acid alkyl esters having a C₁-C₁₀ alkyl radical, such as methyl methacrylate, methyl acrylate, n-butyl acrylate, ethyl acrylate, and 2-ethylhexyl acrylate.

Mixtures of (meth)acrylic acid alkyl esters are also particularly suitable.

Vinyl esters of carboxylic acids having 1 to 20 C atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether or vinyl isobutyl ether. Preference is given to vinyl ethers of alcohols comprising 1 to 4 C atoms.

Hydrocarbons having 2 to 8 C atoms and one or two olefinic double bonds include ethylene, propylene, butadiene, isoprene, and chloroprene.

Preferred principal monomers are in particular C₁ to C₈ alkyl acrylates, C1 to C8 alkyl methacrylates, vinylaromatics, especially styrene, and mixtures thereof.

Very particularly preferred are methyl acrylate, methyl methacrylate, ethyl acrylate, n-butylacrylate, n-hexylacrylate, octylacrylate and 2-ethylhexylacrylate, and styrene, and mixtures of these monomers.

The polymer is preferably a polyacrylate. A polyacrylate is a polymer which is synthesized in total to an extent of at least 50% by weight, preferably at least 70% by weight, of C₁ to C₂₀ alkyl (meth)acrylates (including the branched C10 alkyl (meth)acrylate); the amount of the branched C10 alkyl (meth)acrylate in the polymer is in this case at least 10% by weight (all weight figures are based on the polymer).

The preferred amount of the branched C10 alkyl (meth)acrylate is as indicated above.

Besides the branched C1-C10 alkyl (meth)acrylate and, if appropriate, the above principal monomers, the polymer may comprise further monomers.

Examples of suitable monomers include those containing hydroxyl groups, especially hydroxyalkyl (meth)acrylates, (meth)acrylamide, glycidyl (meth)acrylate or (meth)acrylonitrile; mention may also be made of crosslinking monomers having at least two reactive groups, preferably ethylenically unsaturated, polymerizable groups, examples being allyl(meth)acrylate, diacrylates, such as butanediol diacrylate.

Mention may be made in particular of monomers containing acid groups or acid anhydride groups (acid monomers for short), examples being monomers containing carboxylic, sulfonic or phosphonic acid groups. Preference is given to carboxylic acid groups or their anhydrides. Mention may be made by way of example of acrylic acid, methacrylic acid, itaconic acid, maleic acid, maleic anhydride or fumaric acid.

In particular the polymer may comprise acid monomers in amounts of 0.1% to 10%, more preferably 0.1% to 5%, very preferably 0.2% to 3% by weight, based on the polymer.

The glass transition temperature of the polymer is preferably −60 to 0° C., more preferably −60 to −10° C., and very preferably −60 to −20° C.

The glass transition temperature can be determined by typical methods such as differential thermoanalysis or differential scanning calorimetry (see, e.g., ASTM 3418/82, midpoint temperature).

The preparation of the polymers takes place preferably by emulsion polymerization; the polymer is therefore an emulsion polymer.

Emulsion polymerization involves polymerizing ethylenically unsaturated compounds (monomers) in water using ionic and/or nonionic emulsifiers and/or protective colloids or stabilizers as surface-active compounds to stabilize the monomer droplets and the polymer particles formed subsequently from the monomers.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers.

As surface-active substances it is preferred to use emulsifiers, whose molecular weights, unlike those of the protective colloids, are typically below 2000 g/mol. Where mixtures of surface-active substances are used the individual components must, as will be appreciated, be compatible with one another, something which in case of doubt can be checked by means of a few preliminary tests. It is preferred to use anionic and non-ionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

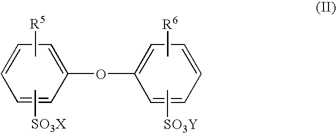

in which R⁵ and R⁶ are hydrogen or C₄ to C₁₄ alkyl and are not simultaneously hydrogen, and X and Y can be alkali metal ions and/or ammonium ions. Preferably R⁵, R⁶ are linear or branched alkyl radicals having 6 to 18 C atoms or hydrogen, and in particular having 6, 12 and 16 C atoms, R⁵ and R⁶ not both simultaneously being hydrogen. X and Y are preferably sodium, potassium or ammonium ions, with sodium being particularly preferred. Particularly advantageous compounds II are those in which X and Y are sodium, R⁵ is a branched alkyl radical having 12 C atoms, and R⁶ is hydrogen or R⁵. It is common to use technical mixtures having a fraction of 50% to 90% by weight of the monoalkylated product, an example being Dowfax® 2A1 (trade mark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Emulsifier trade names are, for example, Dowfax®2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065, Disponil FES 77, Lutensol AT 18, Steinapol VSL, Emulphor NPS 25.

The surface-active substance is used typically in amounts of 0.1% to 10% by weight, based on the monomers to be polymerized.

In the emulsion polymerization use is made typically of water-soluble initiators for the free-radical polymerization of the monomers.

Water-soluble initiators for emulsion polymerization are, for example, ammonium salts and alkali metal salts of peroxydisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of typical redox initiator systems include ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures: for example, a mixture of the sodium salt of hydroxy-methanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1% to 30% by weight, preferably 0.5% to 20% by weight, more preferably 1.0% to 10% by weight, based on the solution.

The amount of the initiators is generally 0.1% to 10% by weight, preferably 0.5% to 5% by weight, based on the monomers to be polymerized. It is also possible for two or more different initiators to be used for the emulsion polymerization.

In the course of the polymerization, polymerization regulators, regulators for short, can also be used in accordance with the invention. Regulators bring about a chain termination reaction and hence reduce the molar weight of the polymer. In the course of this reaction the regulators are attached to the polymer, generally to the chain end.

The amount of regulators can be, in particular, 0.05 to 4 parts by weight, more preferably 0.05 to 0.8 part by weight, and very preferably 0.1 to 0.6 part by weight, based on 100 parts by weight of the monomers to be polymerized. Suitable regulators are, in particular, compounds having a mercapto group, such as tert-butyl mercaptan, thioglycolic acid ethylacrylic esters, mercaptoethynol, mercaptopropyltrimethoxysilane or tert-dodecyl mercaptan. The regulators are generally low molecular weight compounds having a molar weight of less than 2000, in particular less than 1000 g/mol.

The emulsion polymerization takes place in general at 30 to 130, preferably 50 to 90° C. The polymerization medium may be composed either of water alone or of mixtures of water and water-miscible liquids such as methanol. Preferably only water is used. The feed process may be conducted as a staged or gradient procedure. Preference is given to the feed process, in which a portion of the polymerization mixture is introduced as an initial charge and heated to the polymerization temperature, the polymerization of this initial charge is commenced, and then the remainder of the polymerization mixture is supplied to the polymerization zone, typically by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial polymerization charge.

The manner in which the initiator is added to the polymerization vessel in the course of the free-radical aqueous emulsion polymerization is known to the average skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

A portion of the monomers can, if desired, be included in the initial charge to the polymerization vessel at the beginning of the polymerization; the remaining monomers, or all the monomers if no monomers are included in the initial charge, are added in the feed process in the course of the polymerization.

The regulator as well can be included in part in the initial charge, or added in whole or in part during the polymerization or toward the end of the polymerization.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81 083), by adding excess quantities of emulsifier, or by adding miniemulsions. Another advantage associated with the low viscosity at high solids content is the improved coating behavior at high solids contents. One or more new generations of particles can be produced at any point in time. This point in time depends on the particle size distribution which is targeted for a low viscosity.

For the purpose of removing the residual monomers it is also possible to add further initiator after the end of the actual emulsion polymerization (chemical deodorization).

In the emulsion polymerization, aqueous polymer dispersions with solids contents of generally 15% to 75% by weight, preferably of 40% to 75% by weight, are obtained.

The polymer thus prepared is used preferably in the form of its aqueous dispersion.

The polymer is a binder used as in pressure-sensitive adhesives (PSAs).

The PSA comprises the polymer preferably in the form of the aqueous polymer dispersion as has been obtained, or is obtainable, by emulsion polymerization.

The PSA may be composed exclusively of the polymer, or of the aqueous dispersion of the polymer. The PSA is composed preferably of at least 20% by weight, more preferably at least 40% by weight, very preferably at least 60% by weight (solids, i.e., based on all constituents apart from water or other solvents liquid at 21° C. and 1 bar) of the binder.

Besides the binder, the PSA may comprise further additives.

Suitable examples include a tackifier, i.e., a tackifying resin. Tackifiers are known for example from Adhesive Age, July 1987, pages 19-23 or Polym. Mater. Sci. Eng. 61 (1989), pages 588-592.

Tackifiers are, for example, natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M_{w} of below 30 000. The polyacrylates with preference are composed of at least 60%, in particular at least 80% by weight of C₁-C₈ alkyl (meth)acrylates.

Preferred tackifiers are natural or chemically modified rosins. Rosins are composed predominantly of abietic acid or abietic acid derivatives.

The tackifiers can be added in a simple way to the polymer, preferably to the aqueous dispersions of the polymers. In this case the tackifiers are preferably themselves in the form of an aqueous dispersion.

The amount by weight of tackifiers is preferably 5 to 100 parts by weight, more preferably 10 to 50 parts by weight, based on 100 parts by weight of polymer (solids/solids).

Besides tackifiers, for example, further additives may find use, examples being thickeners, preferably associative thickeners, defoamers, plasticizers, pigments, wetting agents or fillers, in the case of the PSA utility.

Accordingly the PSAs of the invention further comprise, in addition to the aqueous polymer dispersion, if appropriate, tackifiers and/or the above additives.

For improved surface wetting the PSAs may comprise, in particular, wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, in particular 0.1 to 3 parts by weight, per 100 parts by weight of polymer (solids).

The PSAs are suitable for producing self-adhesive articles such as labels, sheets or adhesive tapes. The PSA can be applied by typical methods, such as for example by rolling, knifecoating, spreading, etc., to backings, examples being paper or polymeric films, composed preferably of polyethylene, polypropylene, which may have been biaxially or monoaxially oriented, polyethylene terephthalate, polyvinyl chloride, polystyrene, polyamide or metal. Also suitable in particular are backings having nonpolar surfaces, made for example of polyolefins, especially polyethylene or polypropylene, since the PSA adheres very well to such backings.

The backings may be coated directly, in which case the PSA-coated side of the substrates is generally lined with a release paper (antistick layer), such as with a siliconized paper, in order to protect it; alternatively the backing may also be provided on its reverse with an antistick layer and, after having been coated with the PSA, can be rolled up. Coating may also take place by a transfer method; in other words, the PSA is first coated onto the antistick layer of a secondary backing provided with an antistick layer, and then the backing is laminated on.

The water can be removed preferably by drying at 50 to 150° C. The coated backings may be slit to form, for example, adhesive tapes, labels or sheets.

The self-adhesive articles of the invention have very good adhesive properties, in particular an effective adhesion to the substrates and a high level of cohesion (internal strength in the adhesive layer). They also enjoy effective adhesion to apolar surfaces and are therefore particularly suitable not least for substrates having apolar surfaces, e.g., surfaces of synthetic polymers, especially polyolefin surfaces, e.g., of polyethylene (HDPE or LDPE) or polypropylene.

### EXAMPLES

In a 2-liter polymerization reactor with anchor stirrer and heating/cooling apparatus a mixture of 92.26 g of deionized water and 8.33 g of a 33% by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature are 2.93 g of a 7% strength by weight aqueous solution of sodium peroxodisulfate. After 2 minutes, feed streams 1 and 2 are started and are metered in at a uniform rate over 4 h.

Feed stream 1 was an aqueous emulsion prepared from

| | | |
|---|---|---|
| 257.61 | g | deionized water |
| 30.16 | g | a 31% strength by weight aqueous solution of Emulphor |
| | | NPS 25 (nonyl-phenol polyglycol ether sulfate, sodium |
| | | salt) |
| 13.75 | g | a 20% strength by weight aqueous solution of Emulgator |
| | | 825 (PO) (isooctylphenol + 25 EO) |
| 2.64 | g | acrylic acid (AA) |
| 43.56 | g | methyl acrylate (MA) |
| 44.11 | g | methyl methacrylate (MMA) |
| 433.57 | g | 2-ethylhexyl acrylate (EHA)/2-propylheptyl acrylate |
| | | (PHA) |

Feed stream 2 was 35.36 g of a 7% strength by weight aqueous solution of sodium peroxodisulfate.

After the end of feed streams 1 and 2, stirring was carried out for 30 minutes. Subsequently feed streams 4 and 5 were commenced and were metered in at a uniform rate over 60 minutes.

Feed stream 4 was 5.5 g of a 10% strength by weight aqueous solution of tert-butyl hydroperoxide.

Feed stream 5 was 7.33 g of a 12% strength by weight aqueous solution of acetone disulfite.

After the end of feed streams 5 and 6, the internal temperature of the reactor was lowered to 25° C. The aqueous polymer dispersion obtained had a solids content of 55% by weight.

TABLE 1
Composition of the polymers

| | Comparative | Inventive |
|---|---|---|
| | example (C1) | example (B1) |
| | % by weight | % by weight |
| EHA | 82.7 | 0 |
| PHA | 0 | 82.7 |
| AA | 0.5 | 0.5 |
| MA | 8.4 | 8.4 |
| MMA | 8.4 | 8.4 |

### Performance Testing

The polymer dispersions were coated at a rate of 19 g/m² onto polyethylene film backings (by the transfer method; coating first of silicone paper, and transfer to polyethylene) and were dried at 90° C. for 3 minutes. Subsequently the peel strength (adhesion) was measured.

The PSA-coated backing was slit into test strips 25 mm wide.

For the determination of the peel strength, a test strip 2.5 cm wide was adhered in each case to a polyethylene test element and rolled on once using a roller weighing 1 kg. It was then clamped by one end into the upper jaws of a tension/extension testing apparatus. The adhesive strip was peeled from the test surface at 300 mm/min at an angle of 180°; that is, the adhesive strip was bent around and peeled off parallel to the test plate, and the force needed to achieve this was measured. The measure of the peel strength was the force in N/2.5 cm which resulted as the average value from five measurements.

The peel strength was measured immediately and 24 hours after bonding. (After this time the bond strength has developed fully.)

TABLE 2
Results

| | Peel strength | Peel strength |
|---|---|---|
| | (N/2.5 cm) | (N/2.5 cm) |
| | immediately | after 24 hours |
| B1 | 7.3 | 9.8 |
| C1 | 4.7 | 8.8 |

1. A pressure-sensitive adhesive comprising a synthetic polymer binder, wherein the polymer has been synthesized from 10% to 100% by weight of a C10 alkyl (meth)acrylate and the alkyl group of the C10 alkyl (meth)acrylate is a branched C10 alkyl(meth)acrylate having a propyl group as substituent.

2. The pressure-sensitive adhesive according to claim 1, wherein the branched C10 alkyl (meth)acrylate is selected from the group consisting of 2-propylheptyl (meth)acrylate, 4-methyl-2-propylhexyl (meth)acrylate and mixtures thereof.

3. The pressure-sensitive adhesive according to claim 1, wherein the branched C10 alkyl (meth)acrylate is a mixture of 1% to 99% by weight of 2-propylheptyl (meth)acrylate and 99% to 1% by weight of 4-methyl-2-propylhexyl (meth)acrylate.

4. The pressure-sensitive adhesive according to claim 1, wherein the polymer is composed of at least 30% by weight of the branched C10 alkyl (meth)acrylate.

5. The pressure-sensitive adhesive according to claim 1, wherein the polymer is composed of at least 50% by weight of the branched C10 alkyl (meth)acrylate.

6. The pressure-sensitive adhesive according to claim 1, wherein besides the branched C10 alkyl (meth)acrylate the polymer comprises so-called principal monomers selected from the group consisting of other C₁ to C₂₀ alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, and mixtures of these monomers.

7. The pressure-sensitive adhesive according to claim 1, wherein the polymer is synthesized in total from at least 70% by weight of C₁ to C₂₀ alkyl (meth)acrylates (including the branched C10 alkyl (meth)acrylate and the amount of the branched C10 alkyl (meth)acrylate in the polymer is at least 10% by weight with all weight figures being based on the polymer.

8. The pressure-sensitive adhesive according to claim 1, wherein the polymer is synthesized from 0.05% to 10% by weight of ethylenically unsaturated acid monomer compounds containing an acid group or an acid anhydride group.

9. The pressure-sensitive adhesive according to claim 1, wherein the polymer is an emulsion polymer.

10. The pressure-sensitive adhesive according to claim 1, wherein the pressure-sensitive adhesive is an aqueous pressure-sensitive adhesive.

11. A self-adhesive article comprising the pressure-sensitive adhesive according to claim 1.
